(19) United States
(12) Patent Application Publication
(10) Pub. No.: US 2004/0140259 A1
(43) Pub. Date: Jul. 22, 2004

(54) Membrane flux enhancement

(76) Inventor: James A. Cummings, Escondido, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/348,482

(22) Filed: Jan. 20, 2003

(51) Int. Cl. B01D 71/06

(52) U.S. Cl. 210/500.27; 210/500.41; 210/500.43

(57) ABSTRACT

The water flux of UF and MF membranes is dramatically increased by treatment with an aqueous solution of an organic linear polymer without detrimental decrease in other characteristics of the membrane, e.g. solute-rejection. Particular candidates for such treatment include UF and MF membranes made of PS, PES, PAN, and PVDF. The dramatic effectiveness of treatment with aqueous solutions of PEG having molecular weights between about 2000 and 6000 Daltons is shown.

This invention relates to microporous membranes for liquid separation processes, and more particularly, it relates to methods for increasing the water flux of microporous membranes and even more particularly to microfiltration and ultrafiltration membranes which have been treated by such a method.

### FIELD OF THE INVENTION

Polymeric membranes have, for the last several decades, moved into prominence for liquid separation processes, and somewhat loosely defined categories have become established to refer to such membranes, i.e. reverse osmosis (RO) membranes, nanofiltration (NF) membranes, ultrafiltration (UF) membranes, and mircrofiltration (MF) membranes. These categories generally represent a difference in average pore size, with the four above-enumerated categories ranging from the smallest to the largest pores. For example, microfiltration membranes are often characterized as membranes having an average pore size between about 0.05 μm and about 30 μm; however, ultrafiltration membranes are sometimes said to extend from about 10 μm down to about 0.001 μm. It can thus be seen that there is some overlap in these categories.

Although ultrafiltration and mircofiltration membranes have become well developed commercial products over at least the past two decades, the industry has continually sought to improve the characteristics of these membranes, and one characteristic that has been a target for such improvement has been water flux through the membrane.

### BACKGROUND OF THE INVENTION

Attempts have long been made to increase water flux through membranes used for all of these various categories of separation processes. Such attempts have included treatment of the finished membrane, either chemically and/or physically; a modification of the methods and/or materials used in making the polymeric membranes. For example, U.S. Pat. No. 4,990,294 taught stretching, drying and heat setting of microporous fluorocarbon membranes. U.S. Pat. No. 5,755,964 taught that the treatment of RO or NF membranes having a polyamide discriminating layer could substantially increase in their water flux, by treatment with ammonia or a substituted ammonia. In the early days of cellulose acetate (CA) membranes U.S. Pat. No. 3,873,653 taught that such a low flux asymmetric RO membrane could be converted to a high flux membrane by annealing for 30 minutes at a high temperature to dissolve a low molecular weight plasticizer therein and then quenching in water at room temperature for about 15 minutes. U.S. Pat. No. 4,802,987 taught that cellulose acetate pervaporation membranes could be provided with substantially higher flux for use in aromatic separation processes as a result of being impregnated with 10 to 25 weight percent polyethylene glycol (PEG), which was felt to operate as a pore-stabilizer and prevent pore collapse following drying. U.S. Pat. No. 4,087,388 to Jensen et al. teaches the improvement of water flux through an aromatic, nitrogen-linked, synthetic organic polymeric membrane, such as a polyamide RO membrane, by incorporating a specific type of surfactant in the rinse medium that is used to quench and extract the salts and solvent from such a membrane following its casting; PEG monostearate is disclosed as a preferred nonionic surfactant.

None of these patents that disclosed methods for potentially increasing membrane flux were felt to demonstrate treatment methods that would be satisfactory to increase water flux in ultrafiltration and microfiltration membranes, and the search has continued for improvements.

### SUMMARY OF THE INVENTION

Very generally, the invention provides methods for increasing the water flux of polymeric microporous membranes designed for use in liquid separation processes by treating a fabricated membrane with a solution of a chemical agent that modifies the characteristics of the membrane so as to substantially increase the water flux of the membrane with essentially no concurrent reduction in the solute-retention properties of the membrane, with the chemical agent being one that readily passes through the membrane pores; as a result, improved microporous membranes are obtained which are useful in liquid separation processes.

A method for increasing the water flux of microporous membranes, which method comprises treating a polymeric microporous membrane with a solution of a water-soluble polymer that modifies characteristics of said membrane so as to substantially increase the water flux of the membrane with essentially no reduction in the solute-retention properties for the membrane, said water-soluble polymer being such that it readily passes through the pores of the microporous membrane.

Somewhat more particularly, the invention provides polymeric mircroporous membranes useful for liquid separation processes, particularly membranes having an average pore size between about 0.01 μm and about 5 μm, which as a result of treatment with an aqueous solution of a linear water-soluble polymer having —CH₂-groups and —OH and/or —O-groups, experience an increase in water flux of at least about 50% without a proportional decrease in solute rejection. An ultimate water flux for the treated membrane of greater than 50 liters per square meter per hour per bar of applied pressure (Lmh/bar) is often obtained for UF membranes having an initial water flux of less than 10 Lmh/bar.

In another particular aspect, the invention provides a microporous membrane which is constructed for liquid separation processes which membrane comprises a polymeric membrane having an average pore size between about 0.001 μm and about 30 μm; said membrane having been treated With an aqueous solution of a linear, water-soluble polymer having —CH₂-groups and —OH and/or —O-groups; and as a result of said treatment, said microporous membrane has experienced an increase in water flux of at least about 50% without a proportional decrease in solute rejection.

### DETAILED DESCRIPTION OF THE PREFERRED EMBODIMENTS

The invention provides microporous membranes that exhibit increased water flux when employed in liquid separation processes as a result of their treatment with an aqueous solution of a chemical agent, preferably a water-soluble organic polymer. The microporous membranes that are felt to be most benefitted by this treatment are those which are categorized in the industry as ultrafiltration membranes and microfiltration membranes, and which are made from polymeric materials. Unfortunately, there is no industry standard for the pore sizes that constitute an ultrafiltration membrane, and membranes having pore sizes in the range of 10 microns to about 0.001 micron have been variously referred to as ultrafiltration (UF) membranes. Similarly, there are no tight standards for microfiltration (MF) membranes, so it is particularly difficult to state where ultrafiltration membranes stop and microfiltration membranes begin. Very generally, MF membranes have an average pore size between 0.05 microns and 30 microns. Of primary interest for purposes of this application are those microporous membranes having an average pore size between about 0.01 microns and 5 microns, which membranes are constructed for use in liquid separation processes, such as potable water production, wastewater reclamation and removal of colloids, such as latex paints and oil-water emulsions.

It is believed that a wide variety of polymeric microporous membranes are benefitted by treatment by the method of this invention insofar as the water flux therethrough is very substantially increased with no significant adverse effects in other characteristics such as solute rejection, strength, durability, chemical resistance, etc. Very generally it is believed that any UF and MF polymeric membranes that have been made to date from organic polymers will benefit from treatment by this method. Of particular interest are microporous membranes that are formed of polysulfone (PS), polyethersulfone (PES), polyacrylonitrile (PAN) and polyvinylidenefluoride (PVDF). These polymeric materials have frequently been used to fabricate ultrafiltration and microfiltration membranes, which it has been shown can be benefitted by this treatment to increase the water flux. The membranes are fabricated as they normally have been, and following their fabrication, they are subjected to the treatment of interest. Of greatest interest are polymeric membranes having an average pore size between about 0.01 micron and about 5 microns, and within this category, it has been found that treatments of PS or PES ultrafiltration membranes and PVDF microfiltration membranes have proved particularly beneficial in the enhancement of water flux through these membranes without significant diminution of the solute-rejection capability of the membrane.

The water-soluble chemical agent that is used is a linear polymer having —CH₂-groups and —OH groups and/or —O-groups. It is felt that the linear polymer should have a molecular weight (MW) not greater than about 20,000, and preferably not greater than about 10,000 Daltons, and that is should readily pass through the pores of the membrane being treated. Preferred linear polymers are those having a molecular weight in range of between about 1,000 and 8,000 Daltons. From among this overall category of linear water soluble polymers, a preferred group consists of poly(ethylene glycol), poly(propylene glycol), poly(vinyl alcohol), poly(vinyl acetate), poly(vinyl pyrrolidone), and poly(ethylene glycol ether).

Among the more preferred of the chemical agents are poly(ethylene glycol) (PEG) and poly(propylene glycol) (PPG), and aqueous solutions of these polymers having molecular weights between about 1,000 and about 8,000, and more preferably between about 2,000 and about 6,000 are preferably employed. In any event, the linear polymer should be one that readily passes through the pores of the membrane being treated, i.e. one that is rejected by the membrane being treated in an amount of less than 25%; preferably it should be one that is rejected in an amount less than 15%, and most preferably about 10% or less. The concentration of the linear polymer in the treatment solution can vary between about 10 and 5,000 mg/L. Preferably, the solution contains at least about 50 mg/L, and most preferably, a solution containing about 100 and 1,000 mg/L is used.

It is advantageous that the treatment can be carried out at ambient temperature, and generally a temperature in the range of 0° to 50° C. is conveniently employed. It is not felt that any particular advantage is obtained from operating at either end of this temperature range.

The fabricated membrane can be exposed or subjected to the aqueous solution in any suitable manner that allows the solution to permeate into and/or through the microporous structure; thus, coating, soaking, and other similar methods of application may be employed. The duration of time of exposure does not appear to be critical so long as such permeation does occur. However, while soaking for a slightly longer period is acceptable, the preferred method of treatment uses of pressure or vacuum to cause the solution to pass through the mircroporous membrane. As indicated above, the molecular weight of the linear polymer is chosen such that its rejection by the microporous membrane through which it is being forced to permeate is not greater than about 25% so as to be certain sufficient of the linear polymer reached the interstices of the membrane.

As indicated previously, the significant advantage that results from this treatment is an enhancement of the water flux through such a previously fabricated membrane, and such treatment is carried out so that the membrane will have experienced an increase in water flux of at least about 50% above that which the untreated membrane exhibits under identical conditions of testing. However, such is considered to be a minimum and improvement in the water flux by amounts of 100% to 200% following treatment are common. As will be seen from the examples that follow, improvements of a far greater extent are often surprisingly achieved. It has been found that, following treatment of UF membranes having an initial water flux of less than 10 Lmh/bar, the flux is often increased so that the membrane now exhibits a flux of greater than 10 Lmh/bar and preferably of greater than about 50 Lmh/bar. It is noted that 1 bar=14.5 psia=0.97 atm. As also previously mentioned, the physical characteristics and the solute-rejecting characteristics of the membrane are not substantially adversely affected by the treatment, and the latter is also shown by measurement of solute-rejection capability of a UF membrane under identical test conditions, both before and after treatment in various of the examples that follow.

The following examples set forth illustrative embodiments of the successful application of the method of treatment of the invention to produce superior microporous membranes; however it should be understood that these examples do not constitute limitations upon the scope of the invention which is of course set forth in the claims that are appended hereto.

### EXAMPLE 1

A polysulfone ultrafiltration membrane sold by Special Membrane Technologies, Inc. (SEPRO) as its PS-20 membrane, which is characterized by standard testing as rejecting greater than 97.5% of an aqueous solution of 20,000 Dalton MW PEG was tested for water flux. Six samples of the membrane, each being 2.2 in², were evaluated using a standard sheet membrane system using RO-purified tap water and an average applied pressure of about 2.4 bar (2.37 atm or 2.45 kg/cm²). After operating the test system for five minutes, the pure water flux was measured and was found to be 120 Lmh/bar. This is typical of a UF membrane having a 20,000 MW cutoff.

The six membrane samples were then subjected to a aqueous solution containing 200 mg/L of 6,000 MW PEG in RO-purified tap water. After less than one minute of operation, the water flux was seen to increase dramatically, and testing after about five minutes of operation at 2.4 bar applied pressure shows the flux has increased to an average about 880 Lmh/bar. The membrane rejection rate for this PEG linear polymer is measured also and is found to be quite low, i.e. only about 2.8%.

The six membrane samples were then flushed with RO-purified tap water for about 5 minutes and then cleaned using a caustic cleaner sold commercially as Ultrasil 10. Next, the membrane samples were cleaned with an acidic cleaner sold commercially as Ultrasil 76. As a result of these two cleaning steps, the PEG is essentially completely removed from the membrane samples. Thereafter, the six samples were again tested with RO-purified tap water at an applied pressure of about 2.4 bar, and the average pure water flux that was measured was about 790 Lmh/bar. This indicates that the increased water flux that resulted from the PEG treatment step remains a characteristic of the PS-20 membranes even after its subjection to caustic and acidic cleaning.

The six membrane samples were then retested with a 2000 mg/L aqueous solution of 20,000 MW PEG. Substantially, the same rejection as initially obtained, i.e. a rejection of about 97.5% was measured. Thus, it can be seen that the treatment with the 6000 MW PEG did not adversely affect the solute-rejection characteristic of the PS membrane, namely, its ability to reject the 20,000 MW PEG. However, after this testing with the 20,000 MW PEG to ascertain that this was indeed the case, the water flux of the membranes had as a result dropped to about 20 Lmh/bar, as expected, due to concentration polarization.

### EXAMPLE 2

A polyvinyldene fluoride (PVDF) microfiltration membrane that is manufactured by SEPRO and sold commercially as their PVDF-MF membrane has an average pore size of about 0.15 μm. Two membrane samples of 2.2 square inches each were evaluated using the standard sheet membrane test system. The pure water flux of each was measured at an average applied pressure of about 1.4 bar, again using RO-purified tap water. After operating the system for 5 minutes, the pure water flux was measured and found to be about an average of 114 Lmh/bar.

These membranes were then subjected to treatment with a 200 mg/L solution of 6,000 PEG in RO-purified tap water. Again, after less than one minute of operation, the water flux increased dramatically. After about 5 minutes, the flux was measured, and an average increase to 1026 Lmh/bar was obtained. The PVDF-MF has substantially no rejection for 6000 MW PEG. This nine-fold increase over the pure water flux of the pre-treated membranes is again dramatic.

### Example 2A

An additional group of samples of the PVDF-MF membranes of Example 2 are treated using a 200 mg/L solution of 2000 MW PEG at an applied pressure of about 2.5 bar for two minutes. The average water flux is again found to very substantially increase as a result of this treatment.

### EXAMPLE 3

Samples of another PS UF membrane were tested and found to have an average pure water flux, when tested using RO-purified tap water at an applied pressure of 2.4 bar, of only about 8 Lmh/bar which is considered to be economically unacceptable. Six 2.2 in² samples were treated, as in Example 1, with an aqueous solution containing 200 mg/L of 6000 MW PEG at an applied pressure of about 2.5 bar for two minutes. It was surprisingly found that the pure water flux increased to about 570 Lmh/bar, more than a 70-fold increase.

Other samples of the same membrane were then tested for solute-rejection in a comparison test with those that had just been found to have so dramatically increased in water flux. Both sets of membrane samples were evaluated using the standard solution of 2000 mg/L of 20,000 MW PEG in RO-purified tap water. Both sets of sample membranes were found to reject about 98% of the 20,000 MW PEG.

### EXAMPLE 4

An additional group of six samples, each about 2.2 in², from another low flux PS UF membrane, were flux-tested and found to measure only about 4.6 Lmh/bar. Treatment was carried out using a 200 mg/L solution of 2000 MW PEG at applied pressure of about 2.5 bar for two minutes. The average water flux was then measured and was found to be about 550 Lmh/bar, which represents a 120-fold increase as a result of this treatment.

### EXAMPLE 5

An additional six samples of another PS membrane having an unacceptable water flux of only about 3.2 Lmh/bar were this time subjected to similar permeation treatment using a 200 mg/L aqueous solution of 4000 MW PEG in RO-purified water for two minutes at an applied pressure of about 2.5 bar. The water flux was then measured and showed an increase to about 480 Lmh/bar, which represents about a 150-fold increase.

### EXAMPLE 6

Samples of yet another PS UF membrane were measured and found to have a pure water flux, when tested at 2.5 bar, of only about 7.4 Lmh/bar. These six samples were then treated in an aqueous solution of 200 mg/L of 3500 MW PPG for about 20 minutes. The results of flux testing then showed an average increase to about 12.1 Lhm/bar. Although this was not as dramatic as the increases that had been obtained using the treatment with various of the PEG linear polymers, it did show an increase of water flux of about 65.8%, which is certainly substantial.

### EXAMPLE 7

Samples of a PES UF membrane are tested and found to have an average pure water flux, when tested using RO-purified tap water at an applied pressure of 2 bar, of 400 Lmh/bar. The membrane rejects greater than 95% of a 20,000 MW PEG in aqueous solution. Six 2.2 in² samples are treated as in Example 1, with an aqueous solution containing 200 mg/L of 6000 MW PEG with an applied pressure of about 2.5 bar for two minutes. The pure water flux increases more than two-fold while the membrane continues to reject at least about 95% of the 20,000 MW PEG.

### EXAMPLE 8

Samples of PAN UF membrane are tested and found to have an average pure water flux, when tested using RO purified tap water at an applied pressure of 2 bar, of 84 Lmh/bar. The membrane rejects more than 90% of 20,000 MW PEG in aqueous solution. Six 2.2 in² samples are treated, as in Example 1, with an aqueous solution containing 200 mg/L of 6000 MW PEG using an applied pressure of about 2.5 bar for two minutes. The pure water flux increases more than two-fold while solute-rejection of 20,000 MW PEG in RO-purified tap water does not significantly change.

### EXAMPLE 9

A polyvinyldene fluoride (PVDF) ultrafiltration membrane that is manufactured by SEPRO and sold commercially rejects more than 90% of 75,000 MW poly(vinyl alcohol) in aqueous solution. Membrane samples of 2.2 square inches each are evaluated using the standard sheet membrane test system. The pure water flux of each is measured using RO-purified tap water and found to be about an average of 200 Lmh/bar.

These membranes are subjected to treatment with a 200 mg/L solution of 6000 PEG in RO-purified tap water. After about 5 minutes, the flux shows a substantial increase of more than 100%, while the solute-rejection remains substantially unchanged.

### EXAMPLE 10

Samples of a PS MF membrane are tested and found to have an average pure water flux, when tested using RO-purified tap water, of about 500 Lmh/bar. 2.2 in² samples are treated, as in Example 1, with an aqueous solution containing 200 g/L of 6000 MW PEG. The pure water flux increases more than 100%.

The foregoing examples show that UF and MF membranes can have their water flux increased by more than 50% by treatments embodying the features of this invention. As a result, it is possible to routinely provide UF membranes which will exhibit a water flux of greater than 10 Lmh/bar and which very frequently will exhibit a water flux of at least 50 Lmh/bar even when the initial production membranes have a far lesser water flux, while at the same time continuing to exhibit the solute-rejection expected of UF membranes. In addition, the water flux of MF membranes can be dramatically increased, rendering them far more valuable commercially.

Although the invention has been described with regard to the best mode presently contemplated by the inventor for carrying out his invention, it should be understood that various changes and modifications as would be obvious to one having the ordinary skill in this art may be made without departing from the scope of the invention, which is defined in the claims appended hereto. For example, whereas the examples have stressed treatment by permeation under pressure of the aqueous solution of the organic chemical agent through the membranes, treatment via submergence in a bath of the aqueous treating solution or even coating with the solution might alternatively be employed. The disclosures of all U.S. patents mentioned hereinbefore are expressly incorporated by reference.

Particular features of the invention are set forth in the claims that follow.

1. A microporous membrane which is constructed for liquid separation processes which membrane comprises:
a polymeric membrane having an average pore size between about 0.001 μm and about 30 μm;
said membrane having been treated with an aqueous solution of a linear, water-soluble polymer having —CH₂-groups and —OH and/or —O-groups, which polymer readily passes through the pores of the microporous membrane; and
as a result of said treatment, said microporous membrane has experienced an increase in water flux of at least about 50%, without a proportional decrease in solute rejection.

2. The microporous membrane of claim 1 wherein said membrane is a microfiltration or an ultrafiltration membrane and is formed of polysulfone (PS), polyethersulfone (PES), polyacrylonitrile (PAN) or polyvinylidene fluoride (PVDF).

3. The microporous membrane of claim 1 wherein said linear polymer is selected from the group consisting of poly(ethylene glycol) (PEG), poly(propylene glycol), poly(vinyl alcohol), poly(vinyl acetate), poly(vinyl pyrrolidone), and poly(ethylene glycol ether).

4. The microporous membrane of claim 3 wherein said linear polymer has a molecular weight not greater than about 10,000 Daltons.

5. The microporous membrane of claim 4 wherein said linear polymer is PEG having a MW between about 1000 and about 8000 Daltons.

6. The microporous membrane of claim 1 wherein said linear polymer in said aqueous solution is rejected by said microporous membrane in an amount of not greater than about 10%.

7. The microporous membrane of claim 1 wherein said microporous membrane is a PS or PES ultrafiltration membrane.

8. The microporous membrane of claim 7 wherein said linear polymer solution contains PEG having a MW of about 6000 Daltons.

9. The microporous membrane of claim 8 wherein said PEG is present at between about 50 and about 5,000 mg/L.

10. A method for increasing the water flux of microporous membranes, which method comprises treating a polymeric microporous membrane with a solution of a water-soluble polymer that modifies characteristics of said membrane so as to substantially increase the water flux of the membrane with essentially no reduction in the solute-retention properties for the membrane, said water-soluble polymer being such that it readily passes through the pores of the microporous membrane.

11. The method of claim 10 wherein said microporous membrane is a microfiltration or an ultrafiltration membrane.

12. The method of claim 11 wherein said microporous membrane treatment is carried out under pressure using a system that forces the solution of the chemical agent through the pores the membrane.

13. The method of claim 12 wherein said treatment is carried out at 0-50° C.

14. The method of claim 10 wherein said water-soluble polymer comprises a linear polymer having —CH₂— and —OH and/or —O-groups in its structure.

15. The method of claim 14 wherein said linear polymer is selected from the group consisting of poly(ethylene glycol) (PEG), poly(propylene glycol), poly(vinyl alcohol), poly(vinyl acetate), poly(vinyl pyrrolidone), and poly(ethylene glycol ether).

16. The method of claim 14 wherein said water-soluble organic polymer has a molecular weight of about than 10,000 Daltons or less.

17. The method of claim 14 wherein said water-soluble polymer is rejected by the microporous membrane in an amount not greater than about 10%.

18. The method of claim 14 wherein said water-soluble polymer is PEG having a molecular weight between about 1000 and about 8000 Daltons.

19. The method of claim 18 wherein said membrane is a PS, PES, PAN or PVDF membrane.
